(19) United States
(12) Patent Application Publication
(10) Pub. No.: US 2002/0107127 A1
(43) Pub. Date: Aug. 8, 2002

(54) Substantially triangular-shaped over-cap

(75) Inventors: Gerard Laurent Buisson, Cincinnati, OH (US); Benito Alberto Romanach, Mason, OH (US); Peter Michael Searles, Mason, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/010,793

(22) Filed: Nov. 13, 2001

Related U.S. Application Data
(60) Provisional application No. 60/248,089, filed on Nov. 13, 2000.
(60) Provisional application No. 60/248,340, filed on Nov. 13, 2000.

(51) Int. Cl. B31B 1/48

(52) U.S. Cl. 493/80

(57) ABSTRACT

A substantially triangular-shaped over-cap includes a body having a substantially triangular-shaped perimeter with three perimeter corners and three perimeter sides. The over-cap also includes a skirt with a skirt corner extending substantially downwardly from one of the perimeter corners. The skirt corner includes at least one inner extension extending toward an area adjacent the body.

### CROSS-REFERENCE TO RELATED APPLICATIONS

This application claims the benefit of U.S. Provisional Application Nos. 60/248,089 and 60/248,340, each filed Nov. 13, 2000, and each application entirely incorporated herein by reference.

### FIELD OF THE INVENTION

The present invention relates to closures for a container, and more particularly to a substantially triangular-shaped over-cap for use with a substantially triangular-shaped container.

### BACKGROUND OF THE INVENTION

Preshaped snack pieces are typically frangible and might be fragile and easily broken during packaging, shipping and/or other handling operations. Conventional packaging techniques provide bags and/or boxes that can permit a significant number of the snack pieces to break or crush prior to consumption. The well known Pringles® shaped potato chip snack pieces, a product of The Procter & Gamble Company, Cincinnati, Ohio, are individual snack pieces having a “saddle” shape and are packaged in a manner which overcomes disadvantages of the prior art. The Pringles® snack pieces have conventionally been packaged as a single nested stack in a cylindrical container which provides enhanced protection during packaging, shipping and/or other handling. As a result, the Pringles® snack pieces are typically presented to the consumer without breakage.

There is a continuing need for user-friendly, relatively inexpensive containers for packaging frangible snack pieces to provide protection during packaging, shipping and/or other handling. It is further desired to provide over-caps for containers to protect a membrane lid and/or to provide closure to a container after at least partially removing the membrane lid.

It might also be desirable to provide such inexpensive containers for other types of frangible and/or fragile articles to reduce breakage of the articles during shipping and/or other handling, to maintain desirable properties of the articles, and to provide a user-friendly package.

### SUMMARY OF THE INVENTION

Accordingly, it is an object of the present invention to obviate problems and shortcomings of conventional devices used to shield and/or close an end of a container. More particularly, it is an object of the present invention to provide substantially triangular-shaped over-caps which can each be used in combination with a similarly substantially triangular-shaped end of a container.

It is a further object of the present invention to provide a removable over-cap for use as a closure and/or a shield for an end of a container.

It is yet another object of the invention to provide over-caps to facilitate reclosing such containers after initial opening and/or to provide over-caps that protect the end of a container.

In exemplary embodiments, the invention is directed to a substantially triangular-shaped over-cap. The over-cap includes a body having a substantially triangular-shaped perimeter with three perimeter corners and three perimeter sides. The over-cap also includes a skirt including a skirt corner extending substantially downwardly from one of the perimeter corners. The skirt corner includes at least one inner extension extending toward an area adjacent the body. The total length of all of the inner extensions in combination is less than about 70 percent of the total length of the perimeter.

In additional exemplary embodiments, the invention is directed to a substantially triangular-shaped over-cap with a body having a substantially triangular-shaped perimeter with three perimeter sides and first, second and third perimeter corners. The first perimeter corner is bisected by an imaginary line at a bisecting point, such that an imaginary boundary line extends perpendicular to the imaginary bisecting line and intersects the imaginary bisecting line at an intersection point. The intersection point is located from the bisecting point a distance of about 20 percent of a maximum width of the perimeter. The imaginary boundary line further intersects the perimeter at two locations to define a perimeter extension therebetween that includes at least a portion of the first perimeter corner. A skirt also extends substantially downwardly from the perimeter extension and includes at least one inner extension extending toward an area adjacent the body. The inner extension includes inner vertical cross-sectional profiles along its length, wherein, outside the perimeter extension, a portion of the perimeter is free of an inner extension having an inner vertical cross-sectional profile that is substantially the same as at least one of the inner vertical cross-sectional profiles within the perimeter extension.

In further exemplary embodiments, a substantially triangular-shaped over-cap is provided with a body having a substantially triangular-shaped perimeter with three perimeter sides. The perimeter further includes a first perimeter corner bisected by a first imaginary line at a first bisecting point, the first imaginary line having a length extending from the first bisecting point to a point of intersection with one of the perimeter sides. The perimeter also includes a second perimeter corner bisected by a second imaginary line at a second bisecting point, the second imaginary line having a length extending from the second bisecting point to a point of intersection with one of the perimeter sides, and a third perimeter corner bisected by a third imaginary line at a third bisecting point, the third imaginary line having a length extending from the third bisecting point to a point of intersection with one of the perimeter sides. A first imaginary boundary line extends perpendicular to the first imaginary bisecting line and intersects the first imaginary bisecting line at a first intersection point. A second imaginary boundary line extends perpendicular to the second imaginary bisecting line and intersects the second imaginary bisecting line at a second intersection point. A third imaginary boundary line extends perpendicular to the third imaginary bisecting line and intersects the third imaginary bisecting line at a third intersection point. The first intersection point is located from the first bisecting point a distance of about 20 percent of the length of the first imaginary line. The second intersection point is located from the second bisecting point a distance of about 20 percent of the length of the second imaginary line. In addition, the third intersection point is located from the third bisecting point a distance of about 20 percent of the length of the third imaginary line. The first imaginary boundary line intersects the perimeter at two locations to define a first perimeter extension therebetween that includes at least a portion of the first perimeter corner. Similarly, the second imaginary boundary line intersects the perimeter at two locations to define a second perimeter extension therebetween that includes at least a portion of the second perimeter corner. The third imaginary boundary line further intersects the perimeter at two locations to define a third perimeter extension therebetween that includes at least a portion of the third perimeter corner. A skirt includes a first skirt portion extending substantially downwardly from the first perimeter extension, a second skirt portion extending substantially downwardly from the second perimeter extension, a third skirt portion extending substantially downwardly from the third perimeter extension. The first skirt portion includes at least one inner extension extending toward an area adjacent the body. The inner extension includes inner vertical cross-sectional profiles along its length, wherein, outside the first, second, and third perimeter extensions, the perimeter is free of an inner extension having an inner vertical cross-sectional profile that is substantially the same as at least one of the inner vertical cross-section profiles within the first perimeter extension.

The substantially triangular-shaped over-cap according to the present invention is advantageous in that it provides a locking mechanism that maintains the over-cap's position on a similarly shaped container, even when a pressure differential arises between the inner and outer sides of the container. In addition, the over-cap may be easily removed from the container by a consumer. These and additional advantages of the over-cap according to the invention will be more apparent in view of the following detailed description.

### BRIEF DESCRIPTION OF THE DRAWINGS

The following detailed description will be more fully understood when viewed together with the drawings in which:

FIG. 1 is a plan view of one exemplary embodiment of an over-cap according to the present invention;

FIG. 2 is a side elevational view of the over-cap set forth in FIG. 1;

FIG. 3 is a cross-sectional view of the over-cap taken along line 3-3 of FIG. 1;

FIG. 4 is an enlarged, partial cross-sectional view of the over-cap of FIG. 1;

FIG. 5 is a partial cross-sectional view of the over-cap of FIG. 1 applied to a container in accordance with one embodiment of the invention;

FIG. 6 is a front perspective view of the over-cap of FIG. 1;

FIG. 7 is a partial cross-sectional view of two over-caps of the embodiment set forth in FIG. 1, stacked in an at least partially nested relationship;

FIG. 8 is a partial front elevational view of a second embodiment of an over-cap in accordance with the invention;

FIG. 9 is a partial plan view of a third embodiment of an over-cap in accordance with the present invention; and

FIG. 10 is an exploded front perspective view of a container assembly in accordance with the present invention.

### DETAILED DESCRIPTION OF EXEMPLARY EMBODIMENTS

The over-caps according to the present invention are substantially triangular-shaped and are adapted to cover a similarly substantially triangular-shaped end (e.g., an open or closed end) of a container. While the drawings depict the substantially triangular-shaped over-cap applied to a container having a substantially triangular-shaped opening and corresponding substantially triangular-shaped lip and body, the substantially triangular over-cap can also be applied to other containers that have a variety of shapes. For example, the substantially triangular-shaped over-cap could be used to place over a substantially triangular-shaped end of a container having a body with a circular, rectangular, square or other cross-sectional shape. In exemplary embodiments, the substantially triangular over-cap can be used as a protective shield for an end of a container that is closed with a membrane lid. Thus, the over-cap may protect a membrane lid, thereby limiting or preventing damage and/or inadvertent removal of the membrane lid to maintain proper containment of the articles, such as substantially triangular-shaped articles (e.g., tortilla chips and the like). In addition, or alternatively, the over-cap may be used to provide a closure for an open end of a container. For example, once a membrane lid (if provided) is at least partially removed, the over-cap may be used as a closure for the open-ended container. Therefore, over-caps in accordance with the present invention have a wide range of utility, such as assisting to present consumers with a fresh product having minimum breakage prior to consumption.

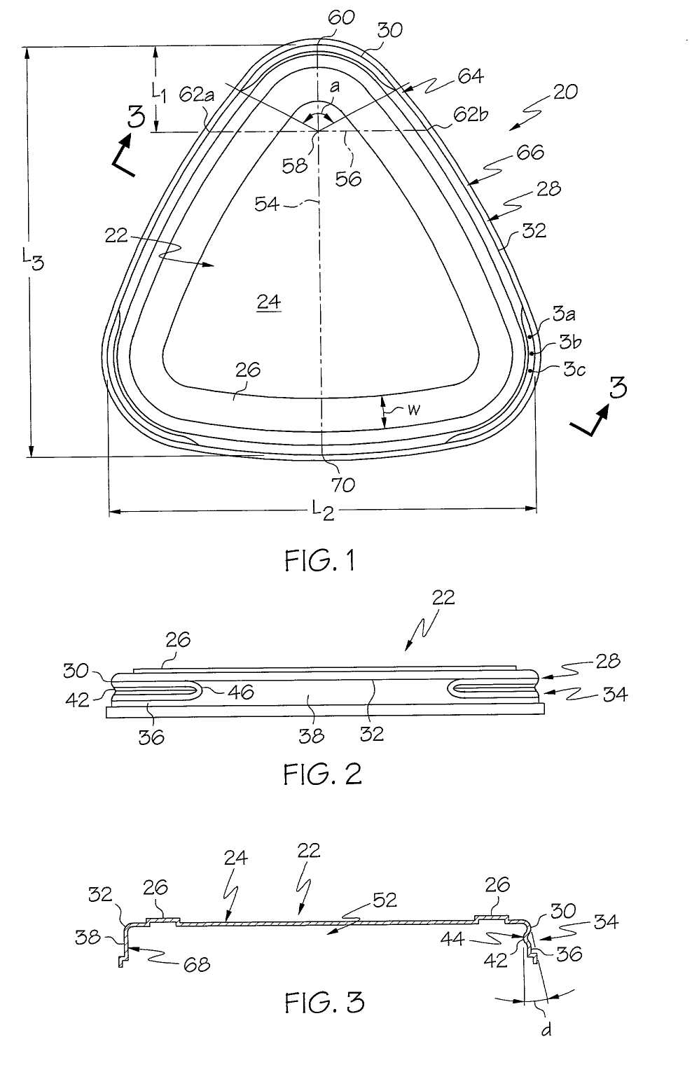

With reference to FIGS. 1-7 and 10, one embodiment of an over-cap 20 comprises a body 22 with a top surface 24 and a substantially triangular-shaped perimeter 28. Within the context of the present invention, “substantially triangular-shaped” includes three-sided polygons with sides that are connected with one another at corners and can comprise a sharp angle or a more rounded configuration. In exemplary embodiments, the corners connect straight or substantially straight sides. Moreover, “straight” can refer to the distance between the corners, rather than any surface or cross-sectional configuration of the sides. In addition, “substantially triangular-shaped” includes shapes that have a substantially equilateral triangular shape, although other shaped triangles (e.g., perimeters with an isosceles triangular, right triangular, or other triangular shape) may be provided with the concepts of the present invention.

The substantially triangular-shaped perimeter 28 of the over-cap 20 includes three perimeter corners 30 and three perimeter sides 32. The over-cap 20 further includes a skirt 34 that may include three skirt corners 36 extending substantially downwardly from corresponding perimeter corners 30 and three skirt sides 38 extending substantially downwardly from corresponding perimeter sides 32.

Although not shown, each of the embodiments of the present invention can include a skirt 34 with less than three skirt corners 36 and/or three skirt sides 38. In exemplary embodiments, the skirt 34 comprises a portion of a single skirt corner 36 or skirt side 38. Reducing the overall size of the skirt may be useful to reduce the amount of material necessary to create the over-cap 20, and therefore reduce material costs. On the other hand, increasing the skirt size may enhance the strength of the skirt and therefore prevent skirt failure. For example, as shown in FIGS. 1-3 and 10, the skirt 34 may extend substantially continuously adjacent the perimeter 28 with three skirt corners 36 and three skirt sides 38 to provide increased rigidity and strength to the over-cap 20.

The over-cap 20 will be dimensioned to accommodate the particular container of interest. Although other dimensions may be used, exemplary embodiments of the over-cap 20 according to the invention has a length L₂ between tangents of the perimeter corners 30, as shown in the drawings, from about 4 cm to about 14 cm, and can be from about 6 to about 9 cm. In one exemplary embodiment, the length L₂ is from about 7.5 cm to about 8.5 cm.

As is further shown in figures, the skirt corner 36 includes at least one inner extension 42 that extends toward an area 52 adjacent the body 22. As illustrated in FIG. 1, for example, the inner extension 42 extends as part of the skirt 34 with a length. In exemplary embodiments, the total length of all of the inner extensions 42 is less than about 70 percent of the total length of the perimeter 28. For example, as illustrated in FIG. 1, the length of each of the inner extensions 42, when added in combination, is less than about 70 percent of the total length of the perimeter 28.

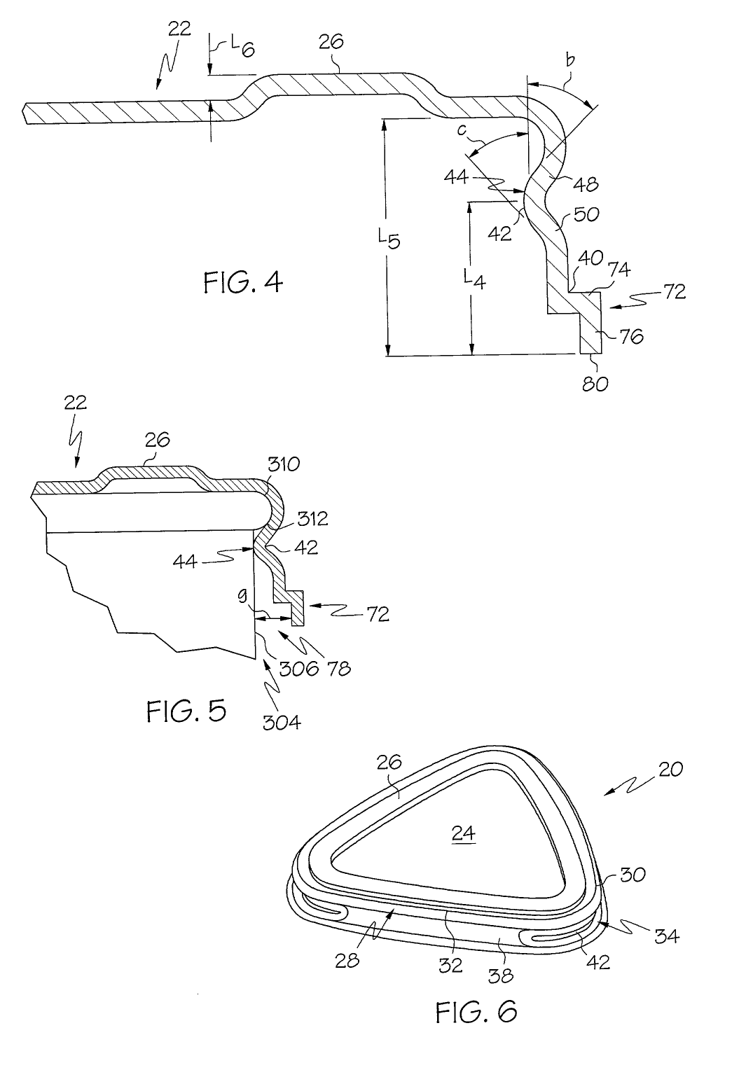

As illustrated in FIGS. 1, 3 and 4, an inner vertical cross-sectional profile 44 can be defined by taking a vertical cross-section through the inner extension 42. In fact, each inner extension 42 has a plurality of inner vertical cross-sectional profiles (e.g., sections at points 3a, 3b and 3c of FIG. 1) that can be substantially identical to one another and substantially identical to the profile illustrated in FIG. 4. Thus, each inner extension 42 can have substantially the same inner vertical cross-sectional profile substantially throughout its length. These inner extension features further assist in retaining the over-cap in place in a variety of atmospheric conditions.

FIG. 2 depicts a small portion 46 of the inner extension 42 that may be inconsistent with the remainder of the inner extension. Thus, while the inner extension 42 is illustrated as having substantially the same inner vertical cross-sectional profile substantially throughout its length, a small portion 46 of the ends of the inner extension 42 can be tapered or gradually reduced. Tapering or reducing the ends of the inner extension can facilitate removal of the end cap 20 from a mold after thermoforming the end cap 20.

In additional embodiments, the inner cross-sectional profile can have inconsistent profiles along its length such that the inner extension does not have substantially the same inner vertical cross-sectional profile substantially throughout its length. Providing inconsistent profiles may be useful to further assist in ejecting the over-cap from the mold after thermoforming and can also assist in controlling the gripping characteristics of the over-cap to the container. For example, the ends of the inner extensions can have a significant tapered or elongated transition portion to facilitate ejection of the over-cap from the thermoforming mold and/or to ease removal of the over-cap from the container by the consumer. On the other hand, providing substantially the same vertical cross-sectional profile may ease application of the over-cap to the container. Providing inner extensions with substantially the same inner vertical cross-sectional profile substantially throughout its length may reduce the required locational precision between the over-cap and container by assisting in aligning the over-cap with the container lip during application and to create a uniform force distribution or contact pressure along the contact points between the inner extensions and the container lip. Reducing the required locational precision between the over-cap and the container limits or prevents inconsistent application, and/or over-cap application failures, due to misalignments between the over-cap and the remainder of the container.

As described above, exemplary embodiments of the present invention include a cumulative length of the inner extensions 42 of less than 70 percent of the total length of the perimeter 28. The remainder of the perimeter includes at least a portion of the perimeter that is free of an inner extension having an inner vertical profile that is substantially the same as at least one of the inner vertical cross-section profiles of the skirt corners. In additional embodiments, at least a portion of the remainder of the perimeter is free of any inner extension. For example, as illustrated in FIG. 3, the perimeter side 32 includes a flat side 68 that is free of any inner extension at the skirt side 38.

In alternative embodiments (e.g., see FIG. 1), at least one perimeter corner 30 is bisected by an imaginary bisecting line 54 at a bisecting point 60. In addition, an imaginary boundary line 56 intersects the imaginary bisecting line 54 at an intersection point 58 and extends perpendicular from the imaginary bisecting line 54. The intersection point 58 is located a distance L₁ from the bisecting point 60. In exemplary embodiments, each inner extension 40 may occupy a portion of the corner radial circumference corresponding to angle “a” originating at the intersection point 58. The angle “a” can comprise a wide variety of ranges. For example, the angle “a” can range from about 10° to about 180°, for example from about 40° to about 160°. In one exemplary embodiment, angle “a” is about 120°. In further exemplary embodiments, the distance L₁ can be about 20 percent of the maximum width of the perimeter 28 wherein the maximum width can be the distance between imaginary vertical lines that are tangent to points of the perimeter corners (e.g., see L₂ in FIG. 1). The imaginary boundary line 56 further intersects the perimeter at two boundary line intersection locations 62a, 62b to define a perimeter extension 64 therebetween that includes the corresponding perimeter corner 30.

The skirt 34 includes portions that extend downwardly from the perimeter extension 64. Although not shown, each of the embodiments of the present invention can include a skirt 34 with less than three skirt corners 36 and/or less than three skirt sides 38. In exemplary embodiments, the skirt 34 comprises a portion of a single skirt corner 36 or skirt side 38. In still further embodiments, as illustrated in the drawings, the skirt 34 may include three skirt corners 36 and three skirt sides 38 extending downwardly from the perimeter 28.

As illustrated in FIG. 3, portions of the skirt 34 extend downwardly from the perimeter extension 64 of the perimeter 28. The skirt 34 further includes at least one inner extension 42 that extends toward the area 52 adjacent the body 22. The inner extension 42 includes inner vertical cross-sectional profiles (e.g., see 44 in FIGS. 3 and 4) along its length. Moreover, a portion 66 of the perimeter 28 is free of an inner extension having an inner vertical cross-sectional profile that is substantially the same as at least one of the inner vertical cross-sectional profiles within the perimeter extension 64. In addition, as illustrated in the exemplary embodiments of FIGS. 1-3, 6 and 10, the portion 66 can be free of any inner extension. For instance, as illustrated in FIG. 3, the perimeter 28 is provided with skirt sides 38 having a flat surface 68 such that a portion of the perimeter 28 is free of any inner extension.

In additional embodiments, a separate imaginary boundary line 64 may be provided relative to each of the imaginary lines bisecting each of the three corners, as described with reference to the single perimeter corner described above, such that the perimeter outside each of the perimeter extensions of each corner is free of an inner extension having an inner vertical cross-sectional profile that is substantially the same as at least one of the inner vertical cross-sectional profiles within each of the perimeter extensions. However, in accordance with the broad nature of the present invention, the concepts presented throughout the application are intended to cover embodiments wherein one or more inner extensions are associated with only one of the perimeter corners and/or with only one of the perimeter extensions. For example, an over-cap can be provided wherein a single perimeter corner includes one or more inner extensions while the remaining perimeter corners are free of inner extensions. The corners that are free of inner extensions can be designed to frictionally engage the lip corners of the container. Alternatively, or in addition, the one or more inner extensions from the single perimeter corner could be complimented by one or more inner extensions on the opposite perimeter side.

In addition, while the inventive concepts described with one or more inner extensions being associated with only one of the perimeter corners and/or with only one of the perimeter extensions may be used with all substantially triangular-shaped perimeters, the single inner extension concept may be particularly useful with non-equilateral triangular-shaped perimeters. For example, with regard to substantially isosceles-triangular-shaped perimeters with two substantially equal angled perimeter corners and a smaller third perimeter corner, the one or more inner extensions can be defined with respect to the smaller corner. In addition, with regard to substantially isosceles-triangular-shaped perimeters with two substantially equal angled perimeter corners that are smaller than the third perimeter corner, the one or more inner extensions can be defined with respect to either of the smaller corners.

In still further embodiments of the present invention, each perimeter extension is defined relative to the bisecting line of the corresponding perimeter corner. As illustrated in FIG. 1, one perimeter extension 64 can be described relative to the imaginary bisecting line 54 of the corresponding perimeter corner 30. In a similar manner, it is understood that two additional perimeter extensions can be defined with respect to the remaining two perimeter corners. Therefore, for purposes of discussion, the perimeter extension 64 will be described with relation to one or more of the corners 30.

As illustrated in FIG. 1, each perimeter corner 30 is bisected by an imaginary bisecting line 54. Moreover, the imaginary boundary lines 56 are perpendicular to each of the corresponding imaginary bisecting line 54. The boundary lines 56 intersect each corresponding imaginary bisecting line 54 at an intersection point 58. The intersection points 58 are located from the corresponding bisecting points 60 a distance of about 20 percent of the length L₃ of the corresponding imaginary bisecting line 54 from the bisecting point 60 to a point of intersection 70 with one of the perimeter sides 32 (e.g., the point of intersection is the midpoint of the perimeter side of a substantially equilateral-shaped triangular perimeter). Each imaginary boundary line 56 will therefore intersect the perimeter at two locations 62a, 62b to define a perimeter extension 64 therebetween that includes the corresponding perimeter corner 30. Accordingly, each perimeter extension 64 depends on the length of the corresponding imaginary bisecting line 54, rather than the maximum width of the perimeter 28 as described in relation to other embodiments above.

A skirt 34 is further provided with a skirt portion extending substantially downwardly from each perimeter extension with each skirt portion including at least one inner extension 42 extending toward an area 52 adjacent the body 22. The inner extensions 42 each include inner vertical cross-sectional profiles 44 along its length such that, outside each of the perimeter extensions 64, the perimeter 28 is free of an inner extension having an inner vertical cross-sectional profile that is substantially the same as at least one of the inner vertical cross-sectional profiles within one or more of the perimeter extensions. For example, outside each of the three perimeter extensions 64, the perimeter 28 can be free of an inner extension having an inner vertical cross-sectional profile that is substantially the same as at least one of the inner vertical cross-sectional profiles in each of the perimeter extensions. In additional embodiments, as illustrated in FIG. 1, outside each of the three perimeter extensions, the perimeter has a portion that is free of any inner extension (e.g., see the flat surface 68 of the skirt side 38 in FIG. 3).

Accordingly, each of the embodiments of the present invention include one or more inner extensions in the vicinity of one or more of the perimeter corners and can be located within one or more perimeter extensions as described above. Providing different inner vertical cross-sectional profiles further assists in over-cap retention and facilitates application and removal of the over-cap from the remainder of the container as desired. If skirt sides are provided, it will be desirable to remove or reduce the size or extent of the inner profile at certain locations along the sides to permit the sides to flex or bow outwardly in response to bulging of the container body and/or lip that might occur at higher altitudes. Permitting the sides to flex or bow outwardly results in a grappling effect wherein the corners bend or pivot inwardly toward the area 52 adjacent the body and thereby tightly engaging the underside 312 of the lip 310 (see FIG. 5). Accordingly, when the ratio of the pressure inside the container increases relative to the pressure outside the container, the skirt sides 38 can flex or bow outwardly to cause inward pivoting movement of the skirt corners 36, thereby permitting the inner vertical cross-sectional profile 44 of the inner extensions 42 to grapple the underside 312 of the lip 310. Therefore, decreasing the pressure of the surrounding environment, with respect to the hermetically sealed interior of the container can more tightly bind the over-cap to the container by permitting the inner extensions in the vicinity of the perimeter corners to be forced against the corners of the upper end of the container. Accordingly, the features of the over-caps described herein provides a capped container that can withstand pressure differentials between the inside and outside of the container. One skilled in the art will recognize that the over-cap is therefore suitable to assist in shipping product to various locations under a variety of atmospheric pressure conditions. While over-caps illustrated herein depict one or more inner extensions at each of the three perimeter corners, one or more inner extensions can be provided at a single corner, thereby easing removal of the over-cap from the mold after thermoforming.

In addition, providing different inner vertical cross-sectional profiles further facilitates application of the over-cap during production and removal of the over-cap by the consumer as desired. When applying the over-cap to an end of the container, the sides may easily flex or bow to permit the inner extensions to ride over portions of the container (e.g., portions of the container lip). In addition, the sides may easily flex or bow when releasing the over-cap from the end of the container. To remove the over-cap, the consumer may grasp a skirt corner 36 to pry the over-cap skirt corner away from an upper end portion (e.g., upper lip) of the container to release the corner from the upper end of the container. When prying, the skirt sides may easily flex or bow as the inner extension rides over a portion of the container (e.g., a lip portion of the container). Moreover, once the corner is lifted, the cap may be easily removed since there isn't an inner extension extending along the skirt sides 38 that would otherwise provide additional attachment between the over-cap and the end of the container.

While exemplary embodiments illustrate portions of the perimeter (e.g., portions of the skirt sides 38) being free of any inner extension, other embodiments may include inner extensions that extend partially or entirely about the periphery of the container, thereby forming a continuous inner extension. In such embodiments, however, it is desirable to avoid inner extensions or other structures that would undesirably limit or prevent bowing or flexing of the sides. In addition, it is desirable to avoid inner extensions that would excessively grasp the end of the container, thereby complicating application and removal of the over-cap from the end of the container.

To achieve the foregoing, it is desirable to have a portion of the perimeter that is free an inner extension having an inner vertical cross-sectional profile that is substantially the same as at least one of the inner vertical cross-sectional profiles within the perimeter extension. In exemplary embodiments, at areas outside the perimeter extension and/or areas of the skirt sides, the inner extension may have a less pronounced profile, reduced profile, discontinuous profile, interrupted profile, or the like to facilitate application and removal of the over-cap from the remainder of the container by the consumer, facilitate attachment of the over-cap to the container and/or encourage over-cap retention. In exemplary embodiments, the skirt does not include skirt sides such that portions of the perimeter lack any inner extension.

In one embodiment, as illustrated in the figures, the skirt sides 38, or portions of the perimeter outside of the perimeter extension 64, are free of inner extensions. Providing the skirt with corners including inner extensions and other portions of the perimeter being substantially free of inner extensions permits the over-cap to securely attach to a similarly triangular-shaped container having a lip while permitting a grappling effect to resist pressure differentials between the interior chamber of the container and the environment surrounding the container. Advantageously, permitting flexing of the skirt sides facilitates application of the over-cap while permitting easy removal from the container as desired.

The inner extensions 42 may take a variety of configurations while providing the desirable locking effect. For example, as shown in FIG. 2, at least one skirt corner 34 can include at least one inner extension 42. Moreover, the at least one inner extension could comprise a single inner extension or a plurality of inner extensions. In still other embodiments, the inner extension could extend at least partially or entirely around the circumference of the perimeter corner 30. In alternate embodiments as shown in FIG. 8, the inner extension may comprise one or more inner extending beads 142 which extend relative to the circumference of the perimeter corner 130. As illustrated in FIG. 8, for example, the plurality of inner extending beads 142 may extend at least partially or entirely around the circumference of the perimeter corner 130. The length of the circumference which contains the inner extending beads 142 may be varied as long as a sufficient locking effect is provided with a container lip. For example, as illustrated in FIG. 5, a container 304 includes a container body 306 and a lip 310 at the upper edge of the container body 306. The over-cap 20 of the embodiments of the present invention are designed to lock with the lip 310 of the container 304, thereby connecting the over-cap to the container 304. As illustrated, the inner vertical cross-sectional profile 44 of the inner extension 42 is designed for an interference fit with the lip 310 wherein the profile is capable of snapping over a portion of the outer circumference of the lip 310 and thereafter locking with the lip 310 by engaging an underside 312 of the lip 310. Thus, the inner extensions of each embodiment of the present invention may have an inner vertical cross-sectional profile that is sufficient to provide the required interference fit with a lip to thereby lock on the underside of the lip of a container body.

In exemplary embodiments (e.g., see FIGS. 4 and 5), the inner vertical cross-sectional profile 44 of the inner extension 42 can have a substantially V-shaped profile that is oriented sideways as illustrated in the figures. The substantially V-shaped profile includes an upper leg 48 and a lower leg 50 wherein the upper leg 48 can be arranged at an angle “b” with respect to the vertical while the lower leg 50 can be arranged at an angle “c” with respect to the vertical. As illustrated in FIG. 4, for example, the angle “b” can be from about 15° to about 60°, for example from about 25° to about 40°. In addition or alternatively, the angle “c” can be from about 5° to about 90°, for example, from about 40° to about 60°.

At least a portion or the entire skirt 34 may further include a flange 72 at a lower edge 40 of the skirt 34. FIG. 5, for example, illustrates the flange 72 arranged to provide an area 78 between the flange 72 and the container body 306 to permit gripping by the consumer's finger tips, thereby facilitating removal of the over-cap from its locking position on a container lip 310. In one embodiment, the flange 72 comprises an upper portion 74 extending outwardly from the lower edge 40 of the skirt 34 and a lower portion 76 extending downwardly from the lower edge 40. The inner extensions 42 are sufficiently spaced from the perimeter 28 to fit over the lip 310 of the container 304 in use.

In an exemplary embodiment, each inner extension 42 is arranged in a substantially parallel arrangement with respect to the perimeter 28. Moreover, once the over-cap 20 is installed on the container 304, the inner extensions 42 are also arranged in substantial parallel arrangement with respect to the lip 310 of the container 304. As shown in FIG. 5, the inner extensions 42 allow the over-cap 20 to lock on the underside 312 of the lip 310. Advantageously, the over-cap 20 produces a snapping sound when it is applied to a container 304 after sufficiently forcing the inner extensions 42 over the lip 310. The snapping sound thereby signals a successful locking connection between the over-cap 20 and the container 304.

In one embodiment, the inner extensions 42 are spaced a distance of from about 0.2 cm to about 0.6 from the perimeter 28. In exemplary embodiments, the upper portion 74 extends outwardly from the lower edge 40 of the skirt 34 a distance of from about 0.05 cm to about 0.3 cm, for example from about 0.08 cm to about 0.16 cm. In a further embodiment, the lower portion 76 extends a distance of from about 0.1 cm to about 0.4 cm, for example from about 0.15 cm to about 0.35 cm, downwardly from the upper portion 74. In yet further embodiments, the vertical length L₄ of the portion of the skirt 34 extending from the indentation 42 to the lower end 80 of the downwardly extending lower portion 36 of the flange is from about 0.2 cm to about 0.7 cm. Additionally, the entire vertical length L₅ of the skirt 34 from the point at which it connects with the perimeter 28 to the bottom of the flange 72 can be from about 0.5 cm to about 1.2 cm.

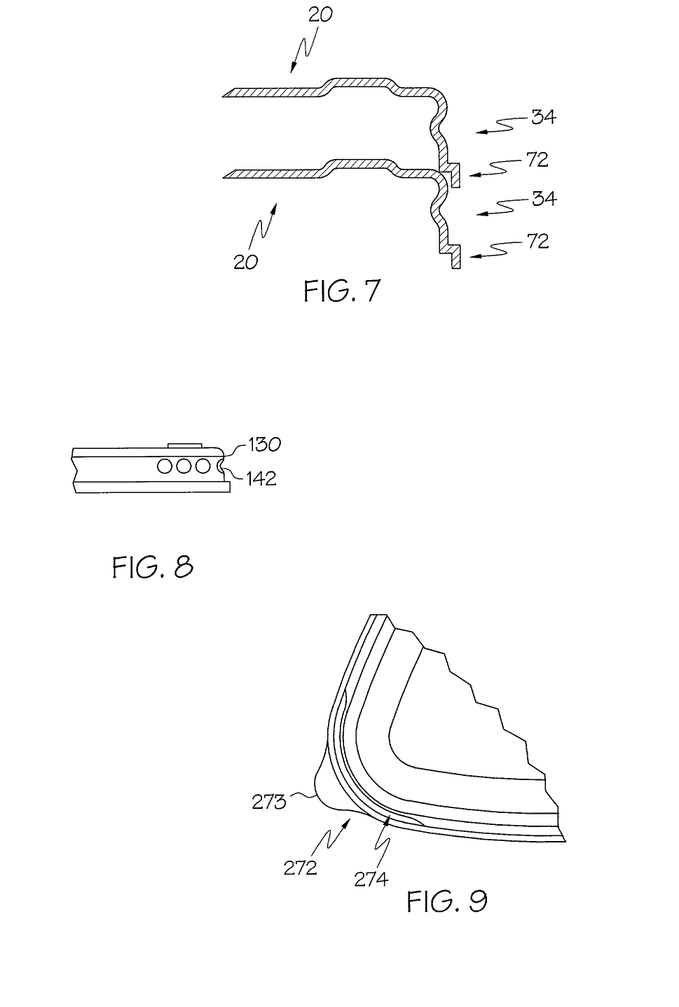

In one embodiment, the flange 72 is dimensioned to allow at least limited nesting of two or more over-caps. For example, as shown in FIG. 7, the flange 72 of an upper over-cap 20 rests adjacent the perimeter 28 of an identical lower over-cap 20.

One skilled in the art will appreciate that the flange 72 may have different configurations. For example, the flange 72 may be in the form of a single outwardly angled, downwardly extending portion to provide the area for insertion of one or more finger tips to easily remove the over-cap from its locking position on a container lip. Alternatively, or in addition, as shown in FIG. 9, the flange 272 may be in the form of a tab 273 extending outwardly from the skirt 274 to facilitate removal of the over-cap.

As is evident from the figures, the lower end of the skirt 34 is outwardly spaced from the top edge of the skirt 34 that is connected adjacent the perimeter 28 of the top surface body 22. This arrangement provides a generally angled skirt to help guide the over-cap over a container body opening and lip and discourages crushing or buckling of the skirt that otherwise might occur without an angled skirt. In addition, providing a generally angled skirt further assists in creating the area 78 between the skirt 34 and the container body 306 after installation of the over-cap 20 to the container 304. As illustrated in FIG. 5, the area 78 can define a gap distance “g” to permit insertion of a consumer's fingertips when prying the over-cap from the container. While many gap distances “g” may be used, a gap distance “g” from about 0.05 cm to about 0.5 cm can be used. In more particular embodiments, a gap distance “g” of about 0.3 cm can be used. Accordingly, providing the skirt with an angled arrangement enhances many functional aspects of the over-cap 20.

In one embodiment, as illustrated in FIG. 3, the lower end 80 of the flange 72 is generally positioned at an angle “d” with respect to the upper end of the skirt 34 at the perimeter 28. The angle “d” can be in the range of from about 3° to about 30°, for example from about 10° to about 20°. In one embodiment, the angle “d” is from about 15° to about 16°. In other exemplary embodiments the angle “d” could be slightly negative while still providing a sufficient gap distance “g”.

The top surface 24 of the over-cap 20 may include one or more protrusions 26 that may improve the aesthetic appearance of the over-cap 20 and/or increase the structural integrity to minimize or eliminate warpage of the body 22 which might otherwise effect the fit of the over-cap 20 with an end of the container and/or the successful application of the over-cap to an end of the container, for example in a high speed packaging process. The protrusion 26 may be of various shapes and/or sizes and may protrude upwardly away from the container or downwardly toward the interior of the container. In the embodiment shown in FIG. 1, the protrusion 26 protrudes upwardly and is positioned inwardly from and adjacent the perimeter 28 of the body 22. The protrusion 26 can extend continuously adjacent the perimeter 28 in a substantially triangular path. The protrusion 26 may extend from the lower portions of the top surface 24 a distance L₆ (see FIG. 4) from about 0.3 mm to about 5 mm, for example about 0.5 mm. In the embodiment shown in FIG. 1, the protrusion 26 might have a width “w” of about 3 to about 10 mm. In one exemplary embodiment, the protrusion 26 has a width of about 7 mm. As will be apparent however, the protrusion 26 may be one embodiment of a strengthening section that may be provided in a variety of shapes and sizes, and may be continuous or noncontinuous as desired, to increase the structural integrity and/or ornamental appearance to the body 22 of the over-cap 20. In addition or alternatively, the strengthening section could comprise a separate piece of material adhered to the body 22. For example, the strengthening section and the body 22 can comprise the same material or can comprise a different material to modify the stiffness of the over-cap as desired. It is also contemplated that the strengthening area could simply involve using a material with increased stiffness without necessarily raising the material to form a protrusion.

The over-cap according to the invention may be formed of any suitable material and according to any manufacturing process known in the art. For example, the over-cap could be thermoformed or even injection molded. In one embodiment, the over-cap may be conveniently formed by a thermoforming operation wherein the cap is formed and cut-in-place. With a thermoforming operation, it may be desirable to provide angles and curvatures to assist in removal of the over-cap from the mold after performing the thermoform process. An even flange may be provided on the skirt perimeter in such an operation. Additionally, the substantially triangular shape of the over-cap allows for specific interlocking of multiple over-cap molds that can minimize laminate scrap in the thermoforming process, thereby reducing material usage and cost of manufacture, particularly as compared with production of round shaped over-caps. Thermoforming operations can typically employ one or more layers of a thermoplastic material, including, but not limited to, polyethylene, polypropylene, polyethylene terephthalate, or the like. In one embodiment, the over-cap is formed of polyethylene terephthalate. Polyethylene terephthalate is a flexible material which resists cracking that otherwise might occur due to mechanical stresses typically experienced during manufacturing and/or application and at a variety of temperatures, particularly colder temperatures which can be encountered during product shipping. In a more specific embodiment, the over-cap is formed from a multi-layer material comprising at least one layer of virgin amorphous polyethylene terephthalate and another layer of reground polyethylene terephthalate. The reground polyethylene terephthalate could be produced from scrap material from previous thermoforming operations. In yet more specific embodiments, the over-cap may be formed of a multi-layer laminate comprising one inner layer of reground polyethylene terephthalate arranged between two outer layers of virgin amorphous polyethylene terephthalate. Typically, thermoformed over-caps may have a material thickness of from about 0.2 mm to about 1 mm. In one embodiment, the over-cap has a material thickness of about 0.4 mm. The over-caps of the present invention can be designed with various thicknesses as desired to provide additional structural support at specific areas, for example, with an injection molding process.

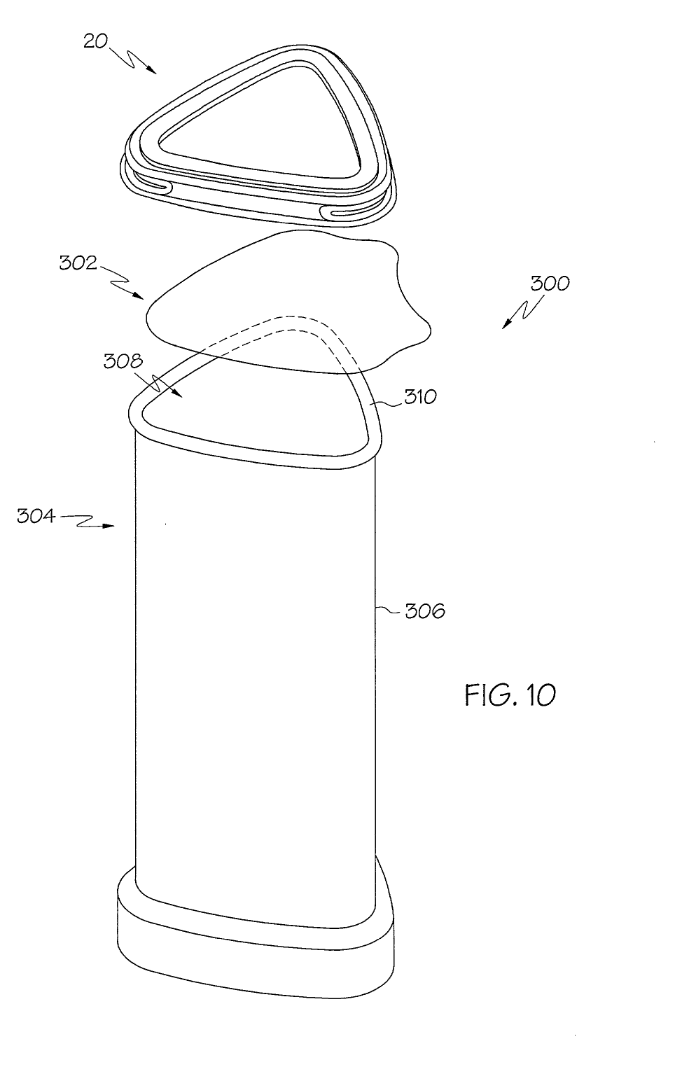

As described above, the over-caps according to the present invention are particularly adapted for shielding and/or closing a similarly substantially triangular-shaped end of a container body. In some embodiments, the container body may also be substantially triangular. For example, as shown in FIG. 10, a container assembly 300 includes a container 304 with a body 306 of a substantially triangular-shaped horizontal cross-section. The container 304 further includes an outwardly extending lip 310 arranged at an open end 308 of the container body 306. The container body 306 and lip 310 may be formed of the same or different materials, as known in the art. In one embodiment, the body and lip are integrally formed of thermoplastic material in an extrusion-blow molding process.

A suitable container is disclosed in the copending application of Buisson et al filed on Nov. 13, 2000, entitled “An Improved Plastic Package for Snack Pieces,” Attorney Docket 8332P, which is incorporated herein by reference. The container may also include a container bottom design as disclosed in the Buisson et al copending U.S. Provisional Application No. 60/248,103 filed on Nov. 13, 2000, entitled “Substantially Triangular-Shaped Container Bottom,” Attorney Docket 8331P and also U.S. patent application Ser. No. ______ entitled “Container Bottom and Methods”, attorneys docket number 8331M, filed herewith, the entire disclosures of which are herein incorporated by reference. The container may further include a lip and/or membrane lid as disclosed in the Buisson et al copending U.S. Provisional Application No. 60/248,026 filed Nov. 13, 2000, and also U.S. patent application Ser. No. ______ entitled “Structures For Providing A Removable Closure”, attorneys docket number 8330M, filed herewith, the entire disclosures of which are incorporated herein by reference.

As illustrated in FIG. 10, the substantially triangular-shaped over-cap 20 according to the invention is adapted to be placed over an end of the container 304 such that the inner extensions 42 of the over-cap 20 engaging an underside 312 of the lip 310. In a further embodiment, a membrane lid 302 (shown in an exploded arrangement in FIG. 10) may be arranged between the over-cap 20 and the lip 310 and attached to an upper surface of the lip 310 to provide a sealed closure. Exemplary membrane lids 302 may be provide moisture and air-tight hermetic seal to contain and preserve food articles packaged in the container 20. The membrane lid 302 may be heat-sealed and/or adhesively attached to the lip 310. After attachment of the membrane lid 302 to an upper surface of the lip 310, the over-cap 20 according to the invention may be applied to the container 20 to shield and thereby protect the membrane lid 302 from damage or inadvertent removal that might otherwise destroy the hermetic condition of the interior chamber of the container. The over-cap 20 may also permit a consumer to reclose the container 304 after at least partial removal of the membrane lid 302.

The specific embodiments and examples set forth above are provided for illustrative purposes only and are not intended to limit the scope of the following claims. Additional embodiments of the invention and advantages provided thereby will be apparent to one of ordinary skill in the art and are within the scope of the claims.

What is claimed is:

1. A substantially triangular-shaped over-cap, comprising:
a) a body having a substantially triangular-shaped perimeter with three perimeter corners and three perimeter sides; and
b) a skirt including a skirt corner extending substantially downwardly from one of the perimeter corners, the skirt corner including at least one inner extension extending toward an area adjacent the body, wherein the total length of all of the inner extensions in combination is less than about 70 percent of the total length of the perimeter.

2. The substantially triangular-shaped over-cap of claim 1, wherein each inner extension has substantially the same inner vertical cross-section profile throughout its length.

3. The substantially triangular-shaped over-cap of claim 1, wherein the skirt includes at least one skirt side with a portion free of an inner extension having an inner vertical cross-section profile along its length that is substantially the same as an inner vertical cross-section profile of the inner extension of the skirt corner along its length.

4. The substantially triangular-shaped over-cap of claim 3, wherein at least one skirt side has a portion free of any inner extension.

5. The substantially triangular-shaped over-cap of claim 3, wherein at least one skirt side includes a portion of the skirt corner inner extension.

6. The substantially triangular-shaped over-cap of claim 1, wherein the skirt corner includes a single inner extension.

7. The substantially triangular-shaped over-cap of claim 1, wherein the skirt corner includes a plurality of inner extensions.

8. The substantially triangular-shaped over-cap of claim 7, wherein at least two inner extensions of the plurality of inner extensions each have a length, wherein the lengths are substantially equal to one another.

9. The substantially triangular-shaped over-cap of claim 1, wherein the skirt includes a flange at a lower edge.

10. The substantially triangular-shaped over-cap of claim 9, wherein the flange comprises an upper portion extending outwardly from the lower edge and a lower portion extending downwardly from the lower edge.

11. The substantially triangular-shaped over-cap of claim 9, wherein the flange comprises a tab.

12. The substantially triangular-shaped over-cap of claim 1, wherein the body has a top surface including a substantially triangular-shaped protrusion.

13. The substantially triangular-shaped over-cap of claim 12, wherein the protrusion is arranged adjacent the perimeter of the body.

14. The substantially triangular-shaped over-cap of claim 1, wherein the inner extension is substantially V-shaped in vertical cross-section.

15. The substantially triangular-shaped over-cap of claim 1, wherein the over-cap has a substantially equilateral triangular shape.

16. A substantially triangular-shaped over-cap, comprising:
a) a body having a substantially triangular-shaped perimeter with three perimeter sides and first, second and third perimeter corners, wherein the first perimeter corner is bisected by an imaginary line at a bisecting point, such that
(i) an imaginary boundary line extends perpendicular to the imaginary bisecting line and intersects the imaginary bisecting line at an intersection point,
(ii) the intersection point is located from the bisecting point a distance of about 20 percent of a maximum width of the perimeter, and
(iii) the imaginary boundary line further intersects the perimeter at two locations to define a perimeter extension therebetween that includes at least a portion of the first perimeter corner; and
b) a skirt extending substantially downwardly from the perimeter extension, the skirt including at least one inner extension extending toward an area adjacent the body, the inner extension including inner vertical cross-sectional profiles along its length, wherein, outside the perimeter extension, a portion of the perimeter is free of an inner extension having an inner vertical cross-sectional profile that is substantially the same as at least one of the inner vertical cross-sectional profiles within the perimeter extension.

17. The substantially triangular-shaped over-cap of claim 16, wherein, outside the perimeter extension, a portion of the perimeter is free of any inner extension.

18. A substantially triangular-shaped over-cap, comprising:
a) a body having a substantially triangular-shaped perimeter with three perimeter sides, a first perimeter corner bisected by a first imaginary line at a first bisecting point, the first imaginary line having a length extending from the first bisecting point to a point of intersection with one of the perimeter sides, a second perimeter corner bisected by a second imaginary line at a second bisecting point, the second imaginary line having a length extending from the second bisecting point to a point of intersection with one of the perimeter sides, and a third perimeter corner bisected by a third imaginary line at a third bisecting point, the third imaginary line having a length extending from the third bisecting point to a point of intersection with one of the perimeter sides, wherein
(i) a first imaginary boundary line extends perpendicular to the first imaginary bisecting line and intersects the first imaginary bisecting line at a first intersection point, a second imaginary boundary line extends perpendicular to the second imaginary bisecting line and intersects the second imaginary bisecting line at a second intersection point, and a third imaginary boundary line extends perpendicular to the third imaginary bisecting line and intersects the third imaginary bisecting line at a third intersection point,
(ii) the first intersection point is located from the first bisecting point a distance of about 20 percent of the length of the first imaginary line, the second intersection point is located from the second bisecting point a distance of about 20 percent of the length of the second imaginary line, and the third intersection point is located from the third bisecting point a distance of about 20 percent of the length of the third imaginary line, and
(iii) the first imaginary boundary line intersects the perimeter at two locations to define a first perimeter extension therebetween that includes at least a portion of the first perimeter corner, the second imaginary boundary line intersects the perimeter at two locations to define a second perimeter extension therebetween that includes at least a portion of the second perimeter corner, and the third imaginary boundary line further intersects the perimeter at two locations to define a third perimeter extension therebetween that includes at least a portion of the third perimeter corner; and
b) a skirt including a first skirt portion extending substantially downwardly from the first perimeter extension, a second skirt portion extending substantially downwardly from the second perimeter extension, a third skirt portion extending substantially downwardly from the third perimeter extension, the first skirt portion including at least one inner extension extending toward an area adjacent the body, the inner extension including inner vertical cross-sectional profiles along its length, wherein, outside the first, second, and third perimeter extensions, the perimeter is free of an inner extension having an inner vertical cross-sectional profile that is substantially the same as at least one of the inner vertical cross-section profiles within the first perimeter extension.

19. The substantially triangular-shaped over-cap of claim 18, wherein the second skirt portion includes at least one second inner extension extending toward the area adjacent the body, the second inner extension includes second inner vertical cross-sectional profiles along its length, the third skirt portion includes at least one third inner extension extending toward the area adjacent the body, the third inner extension includes third inner vertical cross-sectional profiles along its length, wherein, outside the first, second, and third perimeter extensions, the perimeter is free of an inner extension having an inner vertical cross-section profile that is substantially the same as at least one of the inner vertical cross-section profiles within the second and third perimeter extensions.

20. The substantially triangular-shaped over-cap of claim 18, wherein, outside the first, second, and third perimeter extensions, the perimeter has a portion that is free of any inner extension.
